(19) United States
(12) Patent Application Publication
(10) Pub. No.: US 2006/0226335 A1
(43) Pub. Date: Oct. 12, 2006

(54) Apparatus and a method for the determination of the focal distance

(75) Inventors: Wolfram Runge, Freiburg (DE); Sebastian Pastor, Freiburg (DE); Christoph Egger, Denzlingen (DE)

Correspondence Address: HARNESS, DICKEY & PIERCE, P.L.C., P.O. BOX 828, BLOOMFIELD HILLS, MI, 48303, US

(73) Assignee: Sick AG, Waldkirch/Breisgau (DE)

(21) Appl. No.: 11/385,549

(22) Filed: Mar. 21, 2006

(30) Foreign Application Priority Data
Apr. 7, 2005 (DE) 10 2005 016 029.8

(51) Int. Cl. G02B 27/40

(52) U.S. Cl. 250/201.4

(57) ABSTRACT

The invention relates to an apparatus for the determination of the focal distance of an optical imaging system comprising a first partly reflecting element and a second partly reflecting element which are arranged in the beam path at an angle to the optical axis such that a first portion of the light is reflected at the first element into a first light field, a second portion of the light is reflected at the second element into a second light field and a third portion of the light passes through both elements to form a third light field, and an optical detection device to register at least a part of an interference pattern in the overlap region of the first and second light fields. The invention furthermore relates to an optical imaging system comprising an apparatus in accordance with the invention for the determination of the focal distance and a laser scanner having an optical imaging system in accordance with the invention. Finally, the invention relates to a method for the determination of the focal distance of an optical imaging system with a variable focal distance.

### CROSS-REFERENCE TO RELATED APPLICATIONS

This application claims the benefit of German Patent Application No. 10 2005 016 029.8, filed on Apr. 7, 2005. The disclosure of the above application is incorporated herein by reference.

### FIELD OF THE INVENTION

The invention relates to an apparatus and to a method for the determination of the focal distance of an optical imaging system having a variable focal distance.

### BACKGROUND OF THE INVENTION

Laser imaging systems are used, for example, with barcode scanners. The light of a laser diode is, for example, collimated with the help of an optical device and focused onto a reading field to register a barcode located there. The position of the beam waist, which will be termed the focal distance in the following, determines inter alia at which point a code can be read. The possible spacings of a barcode to be read from the optical system in which a sufficiently accurate reading is possible is limited by the depth of field of the optical imaging system. To enlarge the working region, barcode readers with a variable focal distance are used. For this purpose, for example, the spacing of the laser diode from the collimating device is changed to thus change the focal distance or the position of the beam waist.

So that the focal distance is always located as precisely as possible at that spacing at which the code to be read is also located or to be able to adjust the system accordingly, the focal distance of the barcode scanner must be known.

To know the focal distance precisely, the spacing from the laser diode to the collimator is set accurately to the micrometer in known devices. The adjustment is made, for example in controlled operation, in accordance with a characteristic line which was defined in an optoconstructive manner and/or was learned.

For this purpose, the whole optomechanical arrangement has to have extreme precision and may also not change under realistic operating conditions, that is, for example, with a changing temperature, vibration or due to age.

### SUMMARY OF THE INVENTION

It is the object of the present invention to provide an apparatus for the determination of the focal distance of an optical imaging system, an optical imaging system and a method for the determination of the focal distance of an optical imaging system which permit the instantaneously set focal distance to be determined fast and reliably.

This object is satisfied using an apparatus for the determination of the focal distance of an optical imaging system, an optical imaging system, a laser scanner and/or a method for the determination of the focal distance of an optical imaging system in accordance with the independent claims. The dependent claims are directed to preferred embodiments.

An apparatus in accordance with the invention for the determination of the focal distance has a first partly reflecting element and a second partly reflecting element which are arranged sequentially in the beam path subsequent to the collimating element. The arrangement of the partly reflecting elements is selected at an angle such that a first portion of the light transmitted by the laser light source of the optical imaging system and collimated by the collimating element is reflected at the first partly reflecting element into a first light field. A second portion of the light, which has passed through the first partly reflecting element, is reflected at the second partly reflecting element into a second light field. A third portion of the light, which has passed through both partly reflecting elements, forms a third light field. An optical detection device is provided which is arranged such that it can register at least a part of the interference pattern which results in the overlap region of the first light field and the second light field.

An individual collimator lens or a collimating lens system can e.g. be used as the collimating element.

In a method in accordance with the invention for the determination of the focal distance of an optical imaging system with a variable focal distance, a first part reflecting element and a second part reflecting element are arranged sequentially in the beam path of the laser light transmitted by the laser light source at the side of the collimating element remote from the laser light source. The partly reflecting elements are arranged at an angle to the optical axis such that a first portion of the light coming from the laser light source and from the collimating element is reflected at the first partly reflecting element into a first light field and a second portion of the light is reflected at the second partly reflecting element into a second light field. A third portion of the light passes through both elements and so forms a third light field. The interference pattern in the overlap region of the first light field and the second light field is evaluated to determine the focal distance of the third light field.

Two light fields are therefore decoupled from the beam path of the optical imaging system and are used to determine the focal distance of a third light field. The focal distance found with the help of the apparatus in accordance with the invention or with the help of the method in accordance with the invention permits a precise, optionally regulated, operation of the optical imaging system with a variable focal distance. The measurement can be carried out simply and fast and the apparatus is characterized by a compact design.

The apparatus in accordance with the invention or the method in accordance with the invention can be used particularly advantageously with laser scanners, in particular barcode scanners. Systems of this type often have variable focal distances to have an enlarged working region which is not limited by the depth of field of the optical imaging system.

The first partly reflecting element and the second partly reflecting element can be formed by correspondingly designed partly permeable mirrors. The use of a glass plate, which is preferably plane parallel, is particularly simple and cost-favorable. The main portion of the incident light passes through the glass plate and is available for the illumination of the object to be registered, for example the barcode. Only a low portion of the light is reflected at the first surface of the glass plate and a further low portion is reflected at the second surface of the glass plate. A normal glass plate without any surface coating has, for example, a corresponding Fresnel reflection of a few percent. Orders of magnitude of this type are sufficient to realize the measuring principle in accordance with the invention.

An arrangement is particularly simple in which the first partly reflecting element and the second partly reflecting element are arranged parallel to one another. The measuring principle in accordance with the invention can, however, also be carried out using apparatus or methods in which the two partly reflecting elements are admittedly arranged in a fixed relation to one another, but not necessarily parallel to one another.

Simple and symmetrical relationships result when the partly reflecting elements are arranged at an angle of 45° to the optical axis of the optical imaging system.

The optical detection device in the overlap region of the first light field and second light field can be a focusing screen on which the interference pattern is recorded. The focal distance can thus be set or determined as desired by a comparison with the patterns with a known focal distance.

A simple embodiment provides that a photosensitive and location dependent sensor, for example a CMOS sensor or a CCD sensor is arranged in the overlap region. A one-dimensional sensor which is arranged perpendicular to the interference fringes to be expected in order to measure the spacings of the interference fringes is, for example, cost-favorable and sufficient for the application. In a corresponding evaluation unit, for example a microprocessor, the spacings thus measured can be compared with spacings which were, for example, determined within the framework of a pre-calibration measurement in order thus to be able to draw a conclusion on the focal distance of the optical imaging system.

The invention furthermore relates to an optical imaging system having a variable focal distance with at least one laser light source and at least one collimating, optical element, in particular with a collimator lens. The optical imaging system in accordance with the invention furthermore has an apparatus in accordance with the invention for the determination of the focal distance. A laser diode can e.g. be used as the laser light source. The application is not limited to the use of visible light in this process.

Individual elements of the optical imaging system can be shifted for the changing of the focal distance. For example, the position of the collimating optical element can be changed to shift the position of its image plane. A shift of the laser light source relative to the position of the collimating optical element is, however, particularly simple, whereby the image plane is shifted on the optical axis and the focal distance is thus changed.

The apparatus in accordance with the invention or the method in accordance with the invention permit a regulated operation on the setting of the focal distance. In this process, the signal of the optical detection device can be used to determine the focal distance and to set the relative position of the individual optical elements of the optical imaging system, in particular the position of the laser light source, such that a desired focal distance is obtained. In this process, e.g. the output signal of a sensor in the overlap region of the reflected light fields can be used directly as a regulation parameter.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates, in a schematic representation, the measuring principle of an apparatus in accordance with the invention.

### DETAILED DESCRIPTION OF THE PREFERRED EMBODIMENTS

The following description of the preferred embodiments is merely exemplary in nature and is in no way intended to limit the invention, its application, or uses.

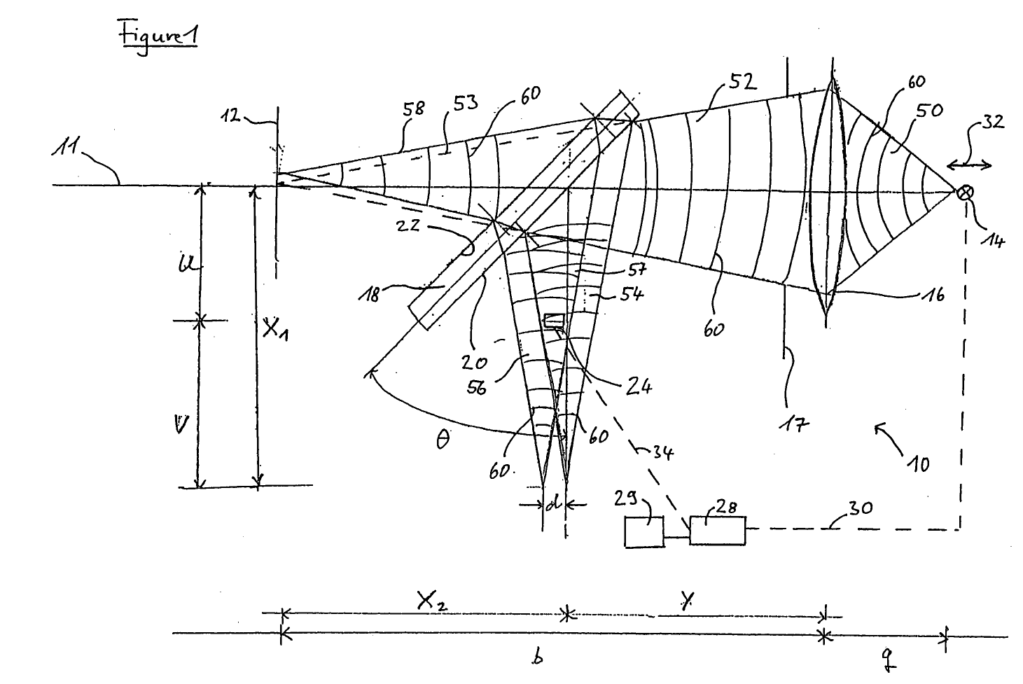

In the example of an optical imaging system 10 shown in FIG. 1, a laser diode 14 is arranged on the optical axis 11. A collimator lens 16 and a diaphragm 17 are arranged in the beam path. The collimator lens 16 only shown schematically can be replaced by an optical system which results in a collimation of the beam path, without it having to be an individual lens.

The light 50 transmitted divergently by the laser diode 14 is collimated by the collimator lens 16 into convergent light 52 bounded by the diaphragm. For clarification, wavefronts 60 are indicated schematically in the light cones 50, 52. If no further elements were in the beam path, the light would be focused in accordance with the chain dotted cone 53 on the imaging plane 12 in the optical axis 11.

A barcode to be registered is located, for example, in a manner not shown in the imaging plane 12. The laser light diode 14 is displaceable in the direction of the arrow 32 on the optical axis to change the position of the imaging plane 12 in order to match the focal distance to the actual position of the barcode. A clear relationship exists between the spacing g of the laser diode 14 from the main plane of the lens 16 and the spacing b of the imaging plane 12 from the main plane of the lens 16:
1/b=1/f−1/g
where f is the focal distance of the collimator lens 16. A displacement of the laser diode 14 in the direction of the arrow 32 therefore changes the focal distance corresponding to the spacing b in a clear manner. FIG. 1 is not to be understood as true to scale, but only as a schematic representation. The spacing of the imaging plane 12 from the collimator lens 16 can thus amount to approximately 2 m, for example.

In the collimated light cone 52, a glass plate 18 having a first surface 20 and a second surface 22 is located at an angle θ=45°. The spacing of the glass plate 18 from the main plane of the collimator lens 16 on the optical axis 11 is marked with Y, whereas the spacing of the imaging plane 12 from the glass plate 18 on the optical axis 11 is named X₂.

A portion of the light 52 is reflected into a first light cone 54 at the first surface 20. After refraction at the first surface 20, a second portion of the light is reflected at the second surface 22 of the glass plate 18 and in turn exits into a second light cone 56 after refraction at the surface 20. With a normal glass plate without any surface coating, approximately 4% is e.g. reflected at the respective surfaces. The overlap range of the light cones 54, 56 has the reference numeral 57.

The major portion of the light passes through the glass plate and forms the third light field 58 which is focused onto the imaging plane 12.

Wavefronts 60 are also indicated schematically in the first, second and third light fields 54, 56, 58.

A one-dimensional CMOS sensor 24 is arranged at a spacing U from the optical axis 11 in the overlap region 57 of the first and second light fields 54, 56 in the shown embodiment and is aligned parallel to the optical axis 11 and can include, for example, 500 pixels of the size 500 μm ×25 μm in one row. The CMOS sensor 24 is connected via a signal lead 24 to an electronic control 28, for example, to a microprocessor which is in turn connected to a memory unit 29. The microprocessor communicates via a control lead 30 with the linear control (not shown) of the laser diode 14 which is used to move the laser diode 14 in the direction of the arrow 32.

The arrangement in accordance with the invention is used as follows.

A barcode to be registered is located, for example, in a manner not shown, in the imaging plane 12 or a barcode is moved in the imaging plane 12. Light 50 of the laser diode 14 is collimated by the collimator lens 16 and is bounded by the diaphragm 17. The light cone 52 created in this manner is incident onto the first surface of the glass plate 18 and is reflected at a low percentage into the first light field 54. The portion of the light field 52 entering into the glass plate 17 is refracted at the surface 20 and reflected at a low percentage at the rear side 22 of the glass plate 18. The light of this portion in turn exits the glass plate at the surface 20 and forms the light field 56. The third light field 58 slightly offset by the glass plate is focused onto the imaging plane 12 and there serves for the registration of the barcode. The evaluation of the barcode takes place in a manner known per se by detection and evaluation devices not shown separately here.

Light fields 54 and 56 interfere in their overlap region 57 and form an interference fringe pattern whose fringes are aligned perpendicular to the Figure plane. The interference fringes are taken with the aid of the CMOS sensor 24 whose signal is guided to the microprocessor 28 via the control lead 34. The spacing of the interference fringes is evaluated here and/or compared with known patterns which are stored in the memory unit 29.

A conclusion on the position of the imaging plane can be made in a clear manner from the spacing of the interference fringes. A determination of the focal distance is therefore possible by a comparison with the patterns stored in the memory unit 29 or with the characteristic spacings. The microprocessor 28 can fix a desired focal distance via the control lead 30 by setting the position of the laser diode 14.

The relationship between the interference pattern measured at the sensor 24 and the position of the imaging plane 12 can be understood as follows in the embodiment shown, with the following explanation only to be understood as a qualitative explanation of the measuring principle.

X1 designates the spacing of the foci of the first and second light fields 54, 56 from the optical axis 11 which are approximately the same in the symmetrical arrangement realized in the embodiment shown and at least with a thickness of the glass plate 18 which is small in comparison with the focal distance b and correspond to the spacing X₂ of the imaging plane 12 from the glass plate 18 at the optical axis 11. d designates the spacing of the foci of the first and second light fields 54, 56 from one another. V designates the difference of X1 and U and in this respect the spacing of the one-dimensional CMOS sensor 24 from the foci of the first and second light fields 54, 56. The following applies:
b=X₂+Y=X₁+Y=V+U+Y.
Since U and Y are constant, there is a direct relationship between the focal distance b i.e. the focal length and the length V.

The position of the interference fringes at the sensor 24 can be estimated with the help of an auxiliary construction which corresponds to a double gap interference experiment in which it is assumed that laser light is transmitted through two gaps at a spacing d at the points of the foci of the light fields 54 and 56 against the beam path of the arrangement considered. At a distance V from the assumed double gap, interference fringes arise at a spacing Δ from one another. The length V (λ: wavelength of the laser light): can be estimated from this from the formulae for the diffraction at the double gap:
V≈(d/λ)·Δ.
It therefore applies to the focal distance b:
b=V+U+Y≈(d/λ)·Δ+U+Y.
There is therefore a reproducible relationship between the focal distance b and the spacing Δ of the interference fringes at the location of the CMOS sensor 24.

Within the framework of a previous calibration measurement, the resulting spacings of the interference fringes can be measured at the location of the detector 24 and stored for different focal distances and can be used for comparison with a respective currently measured measurement value for the spacing of the interference fringes to determine the current focal distance from this.

The description of the invention is merely exemplary in nature and, thus, variations that do not depart from the gist of the invention are intended to be within the scope of the invention. Such variations are not to be regarded as a departure from the spirit and scope of the invention.

| | |
|---|---|
| 10 | optical imaging system |
| 11 | optical axis |
| 12 | imaging plane |
| 14 | laser diode |
| 16 | collimator lens |
| 17 | diaphragm |
| 18 | glass plate |
| 20 | first surface |
| 22 | second surface |
| 24 | CMOS sensor |
| 28 | microprocessor |
| 29 | memory unit |
| 30 | control lead |
| 32 | movement of the laser diode |
| 34 | signal lead |
| 50 | divergent light |
| 52 | convergent light bundle |
| 53 | convergent light bundle without glass plate |
| 54 | first light field |
| 56 | second light field |
| 57 | overlap region of the first and second light fields |
| 58 | third light field |
| 60 | wavefronts |
| g | spacing laser diode - collimator lens |
| b | spacing collimator lens - imaging plane |
| U | spacing glass plate - CMOS sensor |
| X₂ | spacing glass plate - imaging plane |
| Y | spacing collimator lens - glass plate |
| θ | angle of the glass plate to the optical axis |

What is claimed is:

1. An apparatus for the determination of the focal distance of an optical imaging system (10) having a variable focal distance which has at least one laser light source (14) and at least one collimating optical element (16), comprising:
a first partly reflecting element (20) and a second partly reflecting element (22) which are arranged sequentially in the beam path of the laser light (52) transmitted by the laser light source (14) at the side of the at least one collimating element (16) remote from the laser light source (14), wherein the partly reflecting elements (20, 22) are arranged at an angle to the optical axis (11) of the beam path such that a first portion of the light transmitted by the laser light source (14) and collimated by the at least one collimating element (16) is reflected at the first partly reflecting element (20) into a first light field (54), a second portion of the light is reflected at the second partly reflecting element into a second light field (56) and a third portion of the light passes through both partly reflecting elements (20, 22) to form a third light field (58); and
an optical detection device (24) for the registration of at least a part of an interference pattern in the overlap region (57) of the first and second light fields (54, 56).

2. An apparatus in accordance with claim 1, wherein the first partly reflecting element is formed by the front side (20) and the second partly reflecting element is formed by the rear side (22) of a plate (18), which is preferably plane parallel.

3. An apparatus in accordance with claim 2, wherein the plate comprises a glass plate (18).

4. An apparatus in accordance with claim 1, wherein the first and/or second partly reflecting elements (20, 22) is/are arranged at an angle θ of 45° to the optical axis (11).

5. An apparatus in accordance with claim 1, wherein the optical detection device comprises a preferably one-dimensional CCD or CMOS sensor (24).

6. An apparatus in accordance with claim 1, comprising a memory device (29) for the storage of the relationship between the focal distance and interference patterns to be expected.

7. An apparatus in accordance with claim 6, comprising an evaluation unit (28) for the determination of the focal distance from an output signal of the optical detection unit (24) and the stored relationship.

8. An optical imaging system having a variable focal distance, comprising:
at least one laser light source (14);
at least one collimating optical element, in particular a collimator lens (16), in the beam path (52) of the laser light source (14); and
an apparatus for the determination of the focal distance, comprising:
a first partly reflecting element (20) and a second partly reflecting element (22) which are arranged sequentially in the beam path of the laser light (52) transmitted by the laser light source (14) at the side of the at least one collimating element (16) remote from the laser light source (14), wherein the partly reflecting elements (20, 22) are arranged at an angle to the optical axis (11) of the beam path such that a first portion of the light transmitted by the laser light source (14) and collimated by the at least one collimating element (16) is reflected at the first partly reflecting element (20) into a first light field (54), a second portion of the light is reflected at the second partly reflecting element into a second light field (56) and a third portion of the light passes through both partly reflecting elements (20, 22) to form a third light field (58); and
an optical detection device (24) for the registration of at least a part of an interference pattern in the overlap region (57) of the first and second light fields (54, 56).

9. An optical imaging system in accordance with claim 8, wherein the focal distance can be set by changing the spacing (7) of the laser light source (14) from the at least one collimating element (16).

10. A laser scanner, in particular a barcode scanner, comprising an optical imaging system in accordance with claim 8.

11. A method for the determination of the focal distance of an optical imaging system having a variable focal distance, in particular of a laser scanner, which has at least one laser light source (14) and at least one collimating optical element (16), comprising:
arranging a first partly reflecting element (20) and a second partly reflecting element (22) sequentially in the beam path of the laser light (52) transmitted by the laser light source (14) at the side of the at least one collimating element (16) remote from the laser light source (14), and at an angle to the optical axis (11) of the beam path, wherein the partly reflecting elements (20, 22) are arranged such that a first portion of the light coming from the laser light source (14) and the at least one collimating element (16) is reflected at the first partly reflecting element (20) into a first light field (54), a second portion of the light is reflected at the second partly reflecting element (22) into a second light field (56) and a third portion of the light passes through both partly reflecting elements (20, 22) to form a third light field (58); and
determining the focal distance of the third light field (58) based on the interference pattern in the overlap region (57) of the first and second light fields (54, 56).

12. A method in accordance with claim 11, wherein one of the first and second partly reflecting elements (20, 22) are introduced into the beam path at an angle of 45° to the optical axis (11) of the optical imaging system.

13. A method in accordance with claim 11, wherein the front side (20) of a partly permeable plate (18), which is preferably plane parallel, is used as a first partly reflecting element and the rear side (22) of the partly permeable plate (18) is used as a second partly reflecting element.

14. A method in accordance with claim 11, wherein the relationship between the focal distance and the interference pattern is determined in advance in a calibration measurement.

15. A method in accordance with claim 14, wherein the current focal distance is determined from the current interference pattern with the help of the relationship determined in the calibration measurement.

16. A method in accordance with claim 11, wherein the spacing of two interference fringes in the overlap region (57) of the first and second light fields (54, 56) are used to determine the focal distance.

17. A method in accordance with claim 11, wherein the signal of a sensor (24), which detects at least a portion of the interference pattern in the overlap region (57) of the first and second reflected light field (54, 56), is used directly or indirectly as a regulation parameter for the regulation of the focal distance of the third light field (58).
